(19) United States
(12) Patent Application Publication
(10) Pub. No.: US 2010/0148517 A1
(43) Pub. Date: Jun. 17, 2010

(54) PENDULUM MECHANISM AND POWER GENERATION SYSTEM USING SAME

(76) Inventor: Paul Duclos, Iles De La Madeleine (CA)

Correspondence Address: GOUDREAU GAGE DUBUC, 2000 MCGILL COLLEGE, SUITE 2200, MONTREAL, QC, H3A 3H3, CA

(21) Appl. No.: 12/297,152

(22) PCT Filed: Jul. 19, 2007
(86) PCT No.: PCT/CA2007/001279

§ 371 Date: Oct. 14, 2008

Related U.S. Application Data
(60) Provisional application No. 60/807,731, filed on Jul. 19, 2006.
(60) Provisional application No. 60/822,802, filed on Aug. 18, 2006.

(51) Int. Cl. F03G 3/06; F03G 7/10

(52) U.S. Cl. 290/1 C; 74/DIG. 9

(57) ABSTRACT

A mechanism for driving a generator, comprising at least one pendulum comprising a mass free to pendulate about an axis of oscillation; an actuator for applying a force to the mass in a direction of pendulation for at least a portion of the pendulation; and a drive train between the at least one pendulum and the generator for transferring energy between the pendulum and the generator. The drive train comprises a drive member mounted to the pendulum for pendulation therewith; a wheel, the drive member applying a reciprocating rotational force to the wheel when pendulating, the rotating wheel driving the drive shaft; and a freewheeling clutch mechanism interposed between the wheel and the drive shaft such that the drive shaft is driven only in a predetermined direction of rotation.

### FIELD OF THE INVENTION

The present invention relates to a pendulum mechanism and power generation system using same. In particular, the present invention relates to a mechanism and method for converting gravity into a rotational movement in order to actuate a device such as a generator.

### BACKGROUND OF THE INVENTION

Using the momentum of a pendulum as a way of producing work has been known for centuries. What has changed is the means for maintaining the pendulum swing as well as the means to convert a substantially linear movement into a movement more readily adaptable for producing useful work.

The prior discloses an apparatus for harnessing the energy derived from the motion of a body of water including: a pendulum assembly having a buoyancy sufficient for maintaining it afloat in the water, a first structure substantially following multidirectional motions of the water and second structure mounted in the assembly for free movement in a plurality of planes with respect to the first structure. The second structure is displaceable by gravity and by forces derived from the movement of the first structure. There is further provided a device connected to the first and second structures for generating a pressure output in response to the force derived from the relative motions between the first and second structures. An arrangement is coupled to the pressure output of the device for utilizing, at lease indirectly, the energy derived from the pressure output.

The prior art also discloses an energy generator including a pendulum suspended at one end and in operative relationship with an external power device, which imparts oscillation movements to the pendulum. The pendulum includes a weight disposed at one end and in operative cooperation with a hydraulic fluid cylinder to increase the hydraulic pressure of the fluid within the cylinder. A power output device receives the high-pressure hydraulic fluid and generates output power. A second embodiment is directed to a power booster wherein energy is transferred between a pendulum and a power-generating device.

Also, the prior art discloses a prime mover that stores mechanical energy in case of an electrical failure. When an electrical failure occurs, the prime mover is activated either manually or automatically by a computer with a battery back up. The prime mover oscillates back and forth in a pendulum-like fashion, which in turn drives an electrical generator in order to produce electricity. The prime mover comprises a base, elements that are rotatably mounted to the base, a pick-up balance that is rotatably mounted to the base and a drive that operatively connects the prime mover to the electrical generator.

There is still a need in the art for an improved pendulum mechanism and power generation system using same.

### SUMMARY OF THE INVENTION

More specifically, there is provided a mechanism for driving a generator, comprising at least one pendulum comprising a mass free to pendulate about an axis of oscillation; an actuator for applying a force to the mass in a direction of pendulation for at least a portion of the pendulation; and a drive train between the at least one pendulum and the generator for transferring energy between the pendulum and the generator.

There is further provided a mechanism for driving a driveshaft, comprising, two pendulums having angular velocities being substantially 90° out of phase; and a drive train between the two pendulums and the driveshaft for transferring energy between the two pendulums and the driveshaft.

There is further provided a drive train for transferring energy between a pendulum and a drive shaft, comprising a drive member mounted to the pendulum for pendulation therewith; a wheel, the drive member applying a reciprocating rotational force to the wheel when pendulating, the rotating wheel driving the drive shaft; and a freewheeling clutch mechanism interposed between the wheel and the drive shaft such that the drive shaft is driven only in a predetermined direction of rotation.

There is further provided a system for generating electricity, comprising a generator; at least one pendulum comprising a mass, said mass free to pendulate about an axis of oscillation; an actuator for applying a force to the mass in a direction of pendulation for at least a portion of the pendulation; and a drive train between the pendulum and the generator for transferring energy between the pendulum and the generator.

There is further provided a method for driving a generator, comprising the steps of: providing at least one pendulum comprising a mass free to pendulate about an axis of oscillation; applying a force to the mass in a direction of pendulation for at least a portion of said pendulation; interconnecting a drive shaft with the generator such that the generator rotates therewith; and converting the pendulation into a rotational movement using a drive train, the drive train rotating the driveshaft in a predetermined direction of rotation.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1a is a schematical view of a mechanism in accordance with an illustrative embodiment of an aspect of the present invention; FIG. 1b is an insert showing a first detail of FIG. 1a; FIG. 1c is an insert showing a second detail of FIG. 1a;

FIG. 2 illustrates a drive train of FIG. 1b;

FIGS. 3A through 3D show graphs representing the force applied to a drive shaft by one or more pendulums via a drive train in accordance with illustrative embodiments of the present invention;

FIGS. 4A through 4C illustrate alternative methods for converting the swing of a pendulum into rotational motion for driving a drive shaft in accordance with alternative illustrative embodiments of the present invention;

FIG. 5 is a functional diagram of the method of operation of the drive train of FIG. 1b;

FIG. 6 illustrates a freewheel exterior to the mechanism of FIG. 1a;

FIG. 7 shows connection of a generator to the mechanism of FIG. 1a;

FIGS. 8a through 8d illustrate alternatives for the present invention;

FIG. 9 is a schematic diagram of an electricity Megawatt power generating assembly, seen from above, activated by air, in accordance with an alternative illustrative embodiment of the present invention;

FIG. 10 is a side view of the electricity generating assembly of FIG. 9; and

FIG. 11 illustrates a first and a second generators directly connected to the flywheel by the drive shaft, with, on each side, respective flywheels.

### DETAILED DESCRIPTION OF THE ILLUSTRATIVE EMBODIMENTS

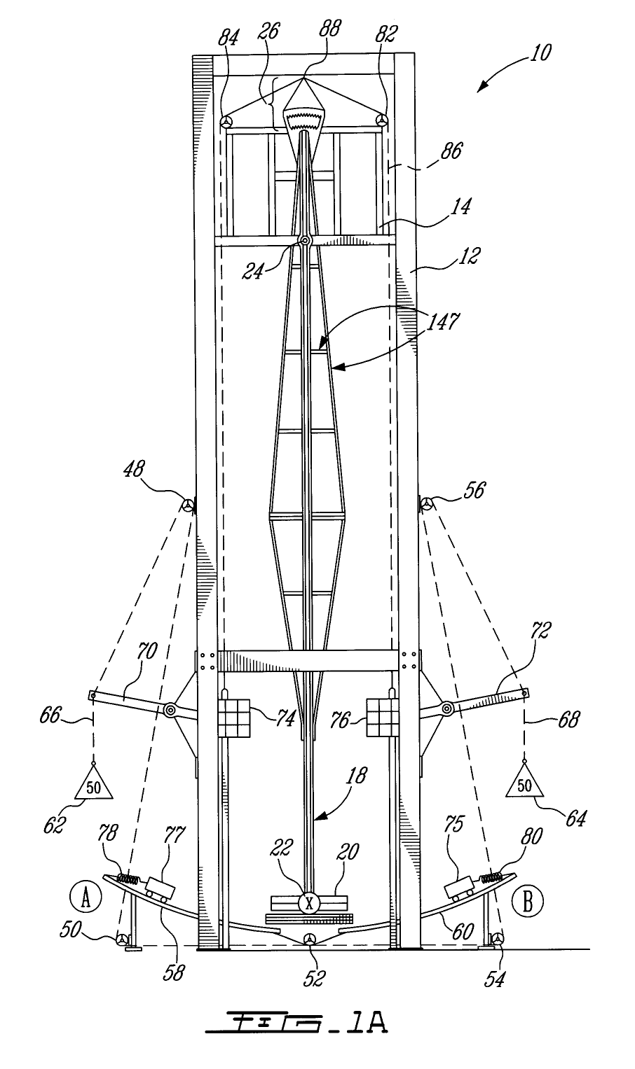

Referring to the FIG. 1, a mechanism 10 according to an embodiment of an aspect of the present invention will be described, referring to side A and side B, respectively.

The mechanism 10 is generally supported by a frame 12, manufactured for example from structural steel, with H beams 8″×10″ for four legs of 32 feet height at a distance of 8×8 feet, providing clearance above the ground for a drive train supporting structure 14 at an elevation of 25 feet.

A pendulum 16 comprises a rod 18 with a mass 20 attached towards a first end 22 of the rod 18. The rod 18 is secured towards its second end to a pivot shaft 24 supported by the drive train supporting structure 14, the pendulum 16 being free to pivot around pivot shaft 24 via roller bearings for example. As shown in FIG. 1a, the rod 18 is a steel rod reinforced by ladders 147 of 1 inch for example, so as to prevent the rod 18 from bending along its length.

As best seen in FIG. 1b, the rod 18 comprises a first part 18a, a second part 18b and a third part 18c. The first part 18a is connected to the mass 20 and has a height of 25 feet, the second part 18b is intermediary, with a length of 5 feet, between the first part 18a and the third part 18c, between a pivots 100 and 102, a last pivot 103 connecting the third part 18c to a drive train 26; the pivots 100, 102, 103 allowing a triple lever effect. Activation of part 18a through action of the mass 20 of 200 lbs at point 22 (see FIG. 1a) activates parts 18b and 18c.

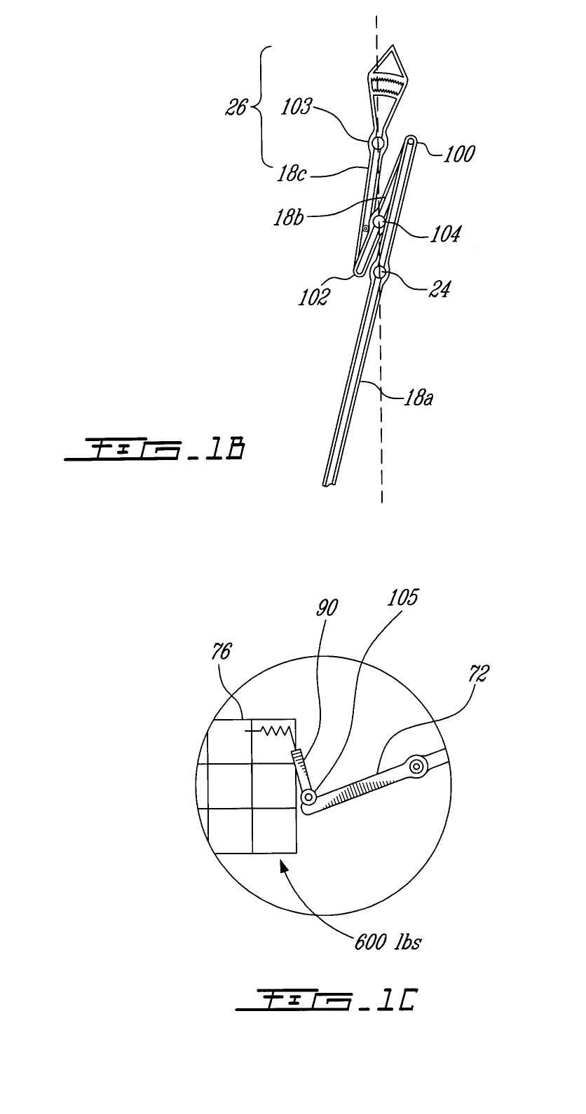

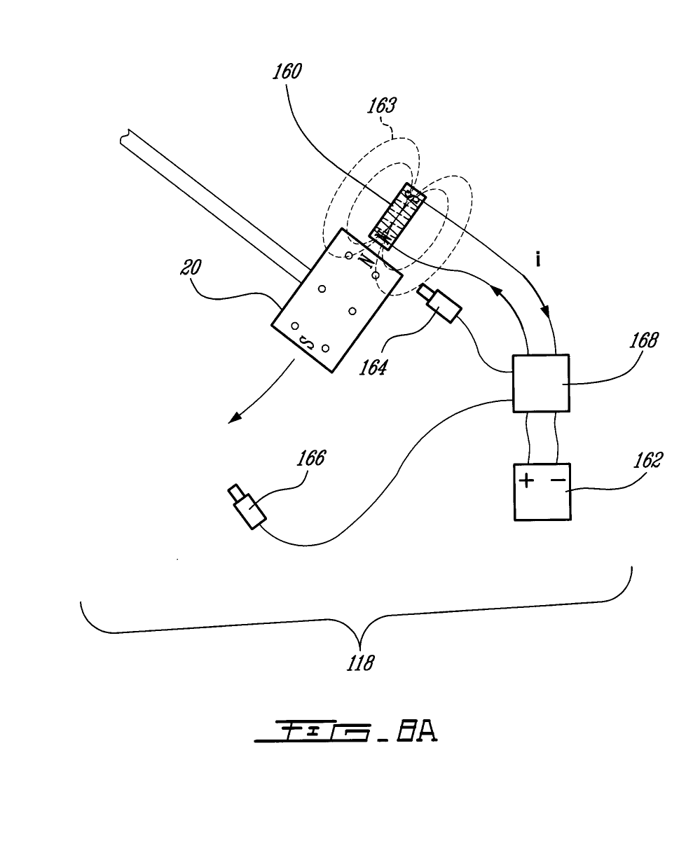

The reciprocating motion of the pendulum 16 is translated into a rotational motion by the drive train 26, shown in more detail in FIG. 2, which is used to drive a flywheel 28 of a weight of 200 pounds (see FIG. 2). In the present illustrative embodiment, the flywheel 28 is free to rotate about a drive shaft 30 connected to the flywheel 28 and a flywheel 280, as will be discussed hereinbelow in relation to FIGS. 6 and 11.

Given the positioning of the drive train 26 and the pivot shaft 24, it will now be apparent to a person of ordinary skill in the art that the drive train 26 takes advantage of the leverage effect obtained through the pivots 100, 102, 103 to concentrate the force brought by the pendulation of the mass 20 and the flywheel 280, as will be explained hereinbelow.

FIG. 6 illustrates a freewheel 280, exterior to the mechanism of FIG. 1a on both sides of structure 12 if necessary, as may be seen for example in FIG. 11 (flywheels 280a and 280). The flywheel 280 has a diameter of 8 feet. Its outer circumference 309 is reinforced by welded plates 306, 308 of a width of 10 inches and a thickness of ⅜ inches.

The flywheel 280 comprises long blades 300 of 4 feet long each, extending radially from a center roller bearing 302. Each blade supports weight blocks 304 of 50 pounds each, from 1 to 10 thereof, depending on the power needed on the flywheel 280 to yield a constant power on a full load generator, as will be discussed hereinbelow. By installing six (or twelve) blades 300 (300′ see dotted lines in FIG. 6), each supporting 10 weight blocks 304, the flywheel 280 may have 3000 (or 6000) pounds of running inertia to maintain a constant drive train effect as will be discussed hereinbelow. The power generator will be mounted on either side of the shaft 30 of FIG. 2, or connected at the center of the flywheel 280 at the center roller bearing 302 (see FIG. 6). Each blade is a metal blade 10 inches wide by ⅜ thick. The blades are secured together by the plates 306, 308 and the circumference of the flywheel itself (see FIG. 6).

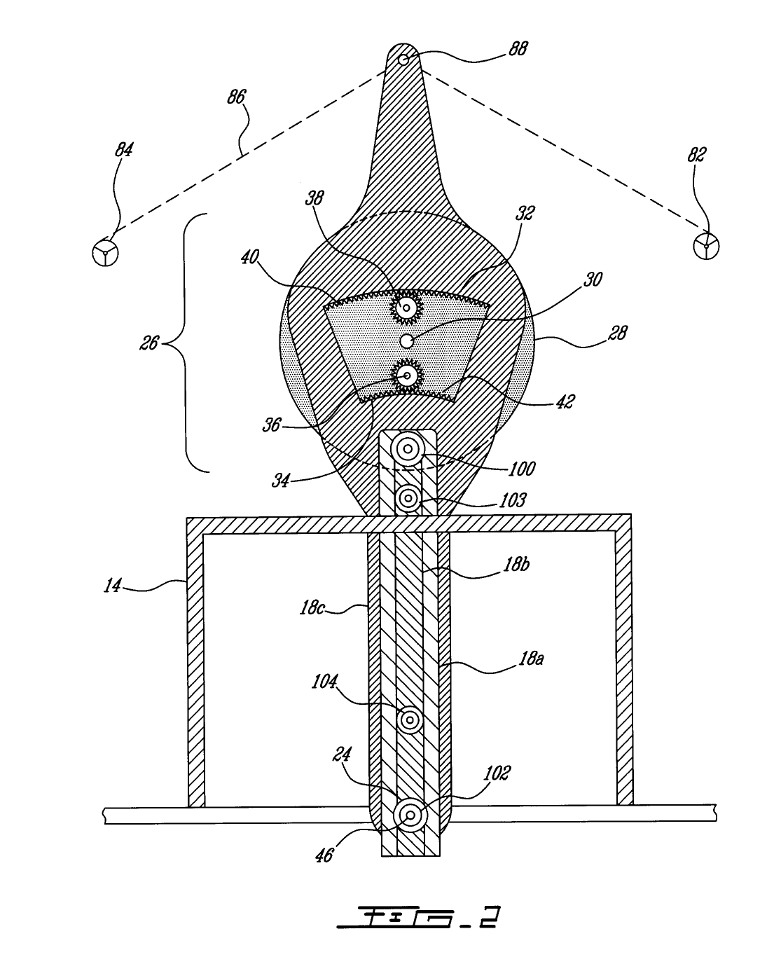

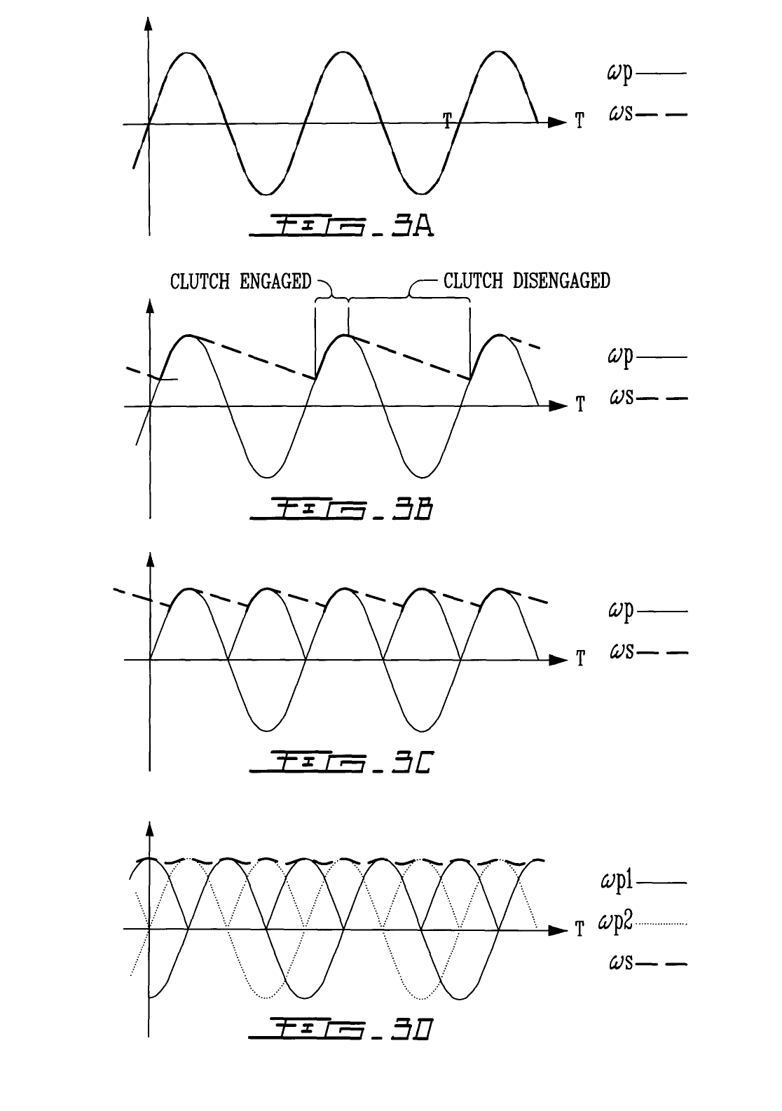

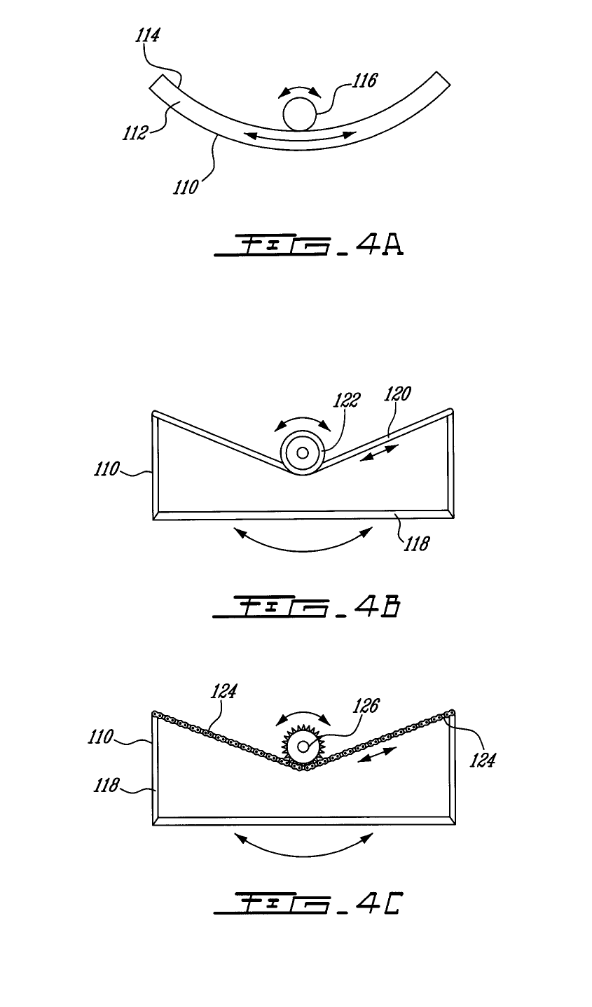

It will be apparent to a person of ordinary skill in the art that the pendulum 16 reaches its maximum angular velocity (or rotational velocity) ωP when the mass 20 reaches its lowest point on its path of travel. It will also be apparent to a person of ordinary skill in the art that, during its period of pendulation, the angular velocity ωP of the pendulum 16 is roughly sinusoidal and varies between this maximum angular velocity and zero, with the direction of angular velocity reversing at the end of each half period. The drive shaft 30, activated and maintained by the flywheel 280, attached to the pendulum 16, through the three levers 18a, 18b and 18c, at the axis of oscillation 24, will have the same characteristic of angular velocity ωS. The angular velocities to of such a pendulum 16 and drive shaft 30 are illustrated by the graph in FIG. 3A.

By interposing a freewheeling clutch with pinions 36 and 38 which engages when a positive drive is applied, and disengages when the drive is negative (i.e. when the drive speed is less than the current speed, or in the reverse direction) between the pendulum 16 and the shaft 30, the force imparted to the shaft 30 by the pendulum 16 can be limited to that portion of the half period of the pendulum during which the clutch is engaged (the forward direction). At other times, in particular when the direction of pendulation of the pendulum is reversed, the transfer through pinions 38 and 36 by the clutch allows the shaft 30 to keep rotating (freewheeling), thereby allowing a short lapse of time of traction on the freewheels 28 and 280. As a result, the angular velocity ωS of the shaft 30 will be the same or greater than the angular velocity of the pendulum ωP in a forward direction and will be maintained by the freewheels 28 and 280 as the pendulum travels in the reverse direction. As a result, the shaft 30 will always spin in the same direction of rotation. The angular velocities of such a pendulum 16 and shaft 30 including the freewheels 28 and 280 are illustrated in the graph of FIG. 3B. The speed at which the shaft 30 slows down can be reduced, thereby providing a more regular angular velocity ωS, by attaching a flywheel having a relatively large moment of inertia to the shaft 30 and by transferring traction from drive members 32, 34 to pinions 36 and 38.

By interposing a gear between the pendulum 16 and the shaft 30, which reverses the direction of the angular velocity of the pendulum, and interposing a freewheeling clutch between this gear and the shaft 30, a force can be applied to the shaft 30 in the direction of rotation as the pendulum travels in the reverse direction. By combining a mechanism that imparts force on the shaft 30 in the direction of rotation as the pendulum 16 travels in a forward direction with a mechanism that imparts force on the shaft 30 in the direction of rotation as the pendulum travels in a reverse direction, the angular velocity ωS of the shaft 30 can be further maintained with the freewheels 28 (of 200 lbs) and 280 (of 3000 or 6000 lbs), especially when increased loads are applied to the shaft 30. The angular velocities of such a pendulum 16 and shaft 30 are illustrated in the graph of FIG. 3C.

By adding a second pendulum 16′ (and a third, or fourth pendulum) of a period which is 90° out of phase with that of the first pendulum 16, combined with the same gearing and freewheeling clutches as discussed in the previous paragraph, the force applied to the shaft 30 can be further regularized. The angular velocities of such pendulums 16, 16′ etc. ωP1 and ωP2 (and ωP3 and ωP4 . . . ) and shaft 30 ωS are illustrated in the graph of FIG. 3D.

As best seen in FIG. 2, an illustrative embodiment of the drive train 26 for imparting force to the drive shaft 30 in accordance with the above principles will now be described.

The drive train 26, securely mounted towards the second end of the third part 18c of pendulum 16 through pivot 102 (see FIG. 1b), comprises upper and lower drive members 32, 34. The drive members 32, 34 drive independent wheels, or pinions, 36, 38 in a reciprocating manner when the pendulum 16 is pendulating about shaft 24.

In the illustrated embodiment, the upper drive member 32 is a rack having a curved toothed inner surface 40 and the lower drive member 34 is a rack having a curved toothed inner surface 42. The toothed surfaces 40, 42 move according to the reciprocating movement of the pendulum 16 and engage the wheels (or pinions) 36, 38 illustratively having outer toothed surfaces that mesh with the toothed surfaces 40, 42 of their respective drive members 32, 34. The radius of each curved toothed surface 40, 42, with a common centre at the pivot shaft 103, are different.

The pinions 36, 38 rotate in opposite directions during oscillations of the parts 18a of rod 18 of pendulum 16, thereby activating parts 18b and 18c of the pendulum 16.

Note that, although in the above illustrative embodiment the drive member is provided as racks 32, 34 which drive pinions 36, 38, other mechanisms for providing an equivalent transfer of energy between the pendulum 16, the flywheel 280 and the shaft 30, which is secured to the freewheel 28, can be foreseen.

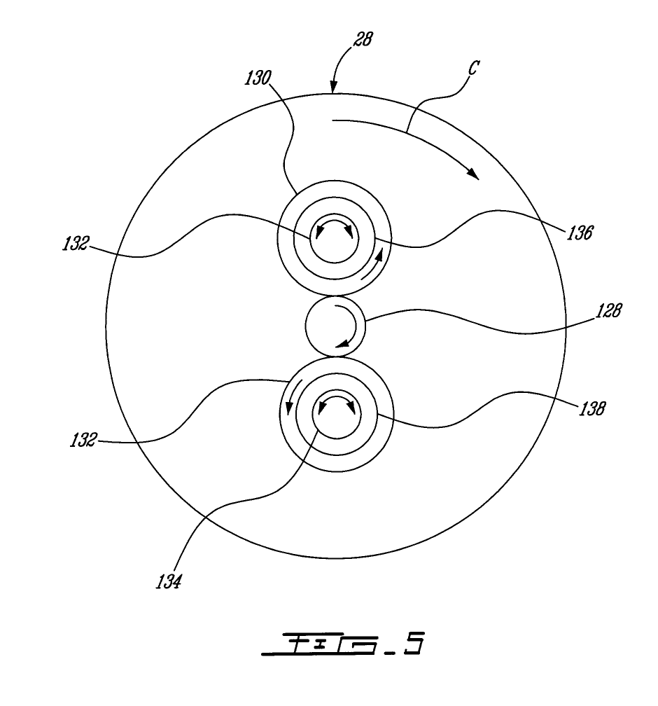

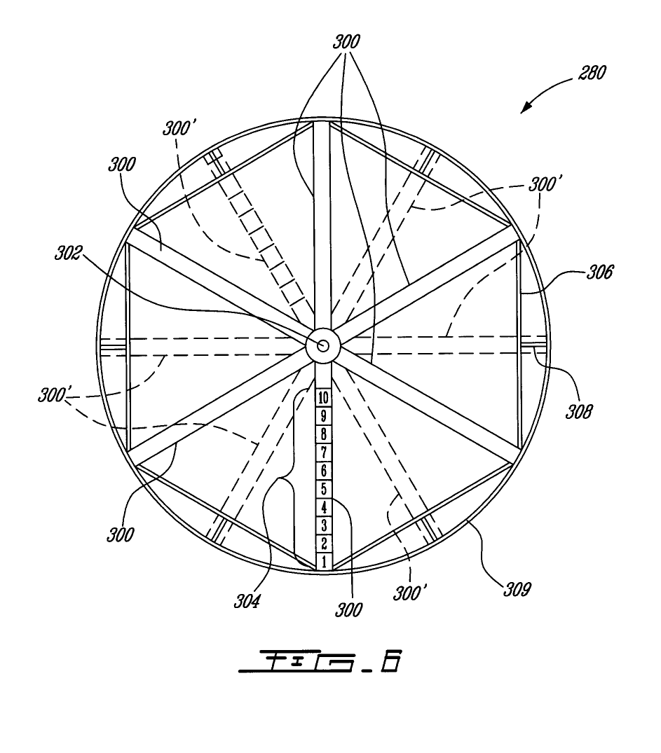

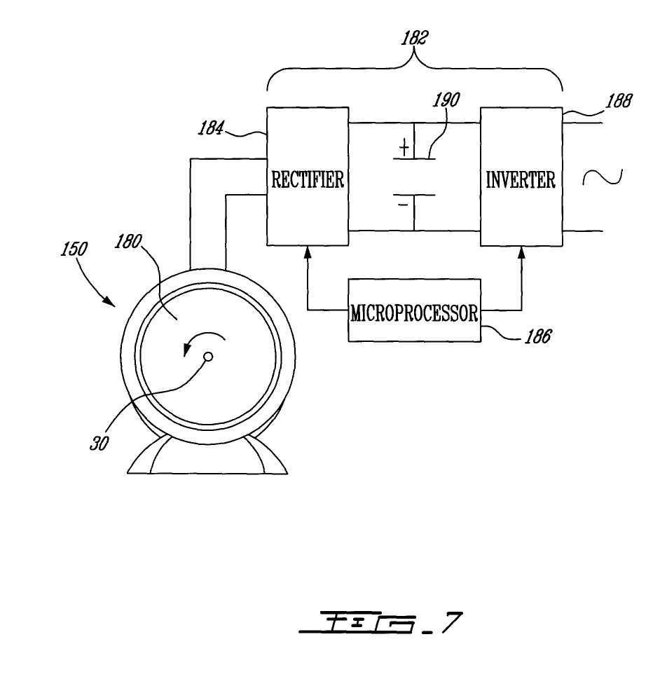

For example, referring to FIG. 4A, a drive member 110 could be comprised of a rigid member 112 mounted to the pendulum (not shown) and having a rough drive surface 114 driving a rubberized wheel 116 or the like.

Alternatively, referring to FIG. 4B, the drive member 110 could be comprised of a structure 118 mounted to the pendulum (not shown) supporting a belt 120 or the like wound around a capstan 122.

Alternatively still, referring to FIG. 4C, the drive member 110 could be comprised of a structure 118 supporting a chain 124 driving a sprocket 126.

Referring now to FIG. 5, in order to drive the flywheel 28 in a clockwise direction (as indicated by the arrow C on the flywheel 28 in FIG. 5) via a cog 128 including the drive shaft 30, cogs 130 and 132 rotate in a counter clockwise direction. As reciprocating shafts 132, 134 are being directly driven by the reciprocating movements of their respective drive members (32, 34), freewheeling clutches 136, 138 ensure that the cogs 130, 132 are engaged only during that portion of their rotation when the angular velocity of their respective reciprocating shafts 132, 134 in a counter clockwise direction would exceed their angular velocity

The pendulum 16 swings about the pivot shaft 24 on a sealed roller bearing or the like.

It will now be apparent to a person of ordinary skill in the art that the wheels (or pinions) 36, 38 rotate in opposite directions during oscillations of the pendulum 16.

Turning back to FIG. 1, the mechanism 10 further comprises a number of pulleys 48, 50, 54 and 56, a double pulley 52, trays 58 and 60, and weights 62, 64.

Each weight 62, 64 is attached by a link 66, 68, to a lever arm 70, 72 respectively. Each lever arm 70, 72 is driven by a block 74 and 76 respectively. Therefore, the lever arms 70, 72 are respectively activated by the blocks 74 and 76 as the blocks 74 and 76 are urged downwards under action of the pendulum.

On side A, the link 66, from the lever arm 70, goes around the pulley 48 attached to the frame 12, then around the pulley 50 at the bottom of the mechanism 10 and finally connects to a weight 75, supported on the tray 60, through the double pulley 52.

Similarly, on side B, the link 68, from the lever arm 72, goes around the pulley 56, and then around the bottom pulley 54, and finally connects to a weight 77, supported on the tray 58, through the double pulley 52.

Therefore, the double pulley 52 guides both links 66 and 68 from the weights 62, 64 to the respective weights 75 and 77.

Each weight 75 and 77 is further connected, at an end opposite to their attachment to links 66 and 68 respectively, to an upper extremity of the curved surface of the trays 60 and 58 respectively, by a respective spring 80, 78 in a counter-weight action arrangement.

The weights 75 and 77, for example mounted on wheels as illustrated, are located on the trays 60, 58 respectively, and able to move on the trays along their curved surface.

Indeed, each tray 58, 60 has a curved surface, distant from the axis 24 by about the length of the rod 18 of the pendulum 16, so the mass 20 of the pendulum 16 is able to contact the weights 75 and 77, on each side of the mass 20, along the trays 58, 60.

The mechanism further comprises another series of pulleys 82, 84, located on each side of a balance point 88, around which a link 86 connects bloc 76 and bloc 74.

As the pendulum 16 moves to side B, the block 74, of 600 lbs for example, through link 86, is moved downwards, thereby activating the lever arm 70, which accumulates the weight of 50 pounds of the weight 62.

By the time the mass 20 reaches its maximum distance on side B, an extension (not shown) of the bloc 74 on the left side (equivalent to an extension 90 latch of bloc 76 on the right side shown in FIG. 1c) unfolds via a wheel and spring mechanism 105, as the weight 62 goes down under gravity. The cable 66 now pulls on weight 75 attached to spring 80, through pulleys 48, 50 and the double pulley 52. At this point, the weight 75 on tray 60 acts on the mass 20, pushing it towards side A.

As the mass 20 of the pendulum 16 comes back to side A, the bloc 76 is urged back down via link 86, which causes the lever arm 72 to go up thereby accumulating a weigh of 50 lbs, for example, corresponding to the weight 64. The same as described hereinabove in relation to bloc 74 then occurs: the latch 90 of the bloc 76 unfolds via a wheel and spring mechanism 105, when the mass 20 of the pendulum reaches its maximum height on side A. As the weight 64 goes down (FIG. 1c), the lever arm 72 goes downwards under gravity due to the weight 64 and the cable 68 pulls on weight 77.

This weight 64 is connected by the cable 68, via pulleys 56, 54 and 52, to the weight 77 on tray 58 (side A). The weight 77, of 50 lbs for example, is attached to the extremity of the tray 58 by the spring 78. The weight 77, which is mobile on tray 58, for example by being provided with wheels as mentioned hereinabove, under action of the weight 64 through cable 68, slides down on inclined tray 58 to the right, thereby pushing the mass 20 of the pendulum 16 towards the right (side B).

Simultaneously, the bloc 74 (of 600 lbs) on side A (left) goes down and lifts up the lever arm 70 to store the weight of weight 62 (50 lbs) as described hereinabove. This occurs because the bloc 74 goes down since the balance point 88 moves to the left. Therefore the mass 20 of the pendulum 16 is to the right (side B) at a maximum height, the extension latch 90 of the bloc 74 (same as illustrated on FIG. 1c for bloc 76) is activated through the mechanism 105 located on the left side of bloc 74 (exactly as illustrated in FIG. 1c in relation to bloc 76), which in turn causes the stored weight 62 (50 lbs) to be lifted up, ready for a possible gravity action. The weight 75 is automatically pulled on tray 60 through link 66, via pulleys 48, 50 and 52, which in turns causes a movement to the left, as described hereinabove in relation to the right side.

When the pendulum 16 is at its maximum left side height, bloc 76 is in turn activated and the same occurs as described hereinabove in relation to bloc 74.

As people in the art will now be able to appreciate, the movement then keeps going.

A perfect synchronism is needed on both sides A and B and positions of blocs 74 and 76.

In the example described hereinabove, the mobile weights 75 and 77, and the weights 62 and 64, are of 50 lbs. The blocs 74 and 76 have a weight proportional to the weight of the mass 20 of the pendulum 16, to create a lever effect. With a mass 20 of 200 lbs at a height of 25 foot, a kinetic force of 600 lbs in movement is obtained, i.e. 600 linear lbs go from side A to side B. When the weight of mass 20 increases, the weight of blocs 74 and 76 are increased too.

The above description is based on a single pendulum 16. The leverage effect will be completed by adding a second, a third or a fourth pendulum, as mentioned hereinabove.

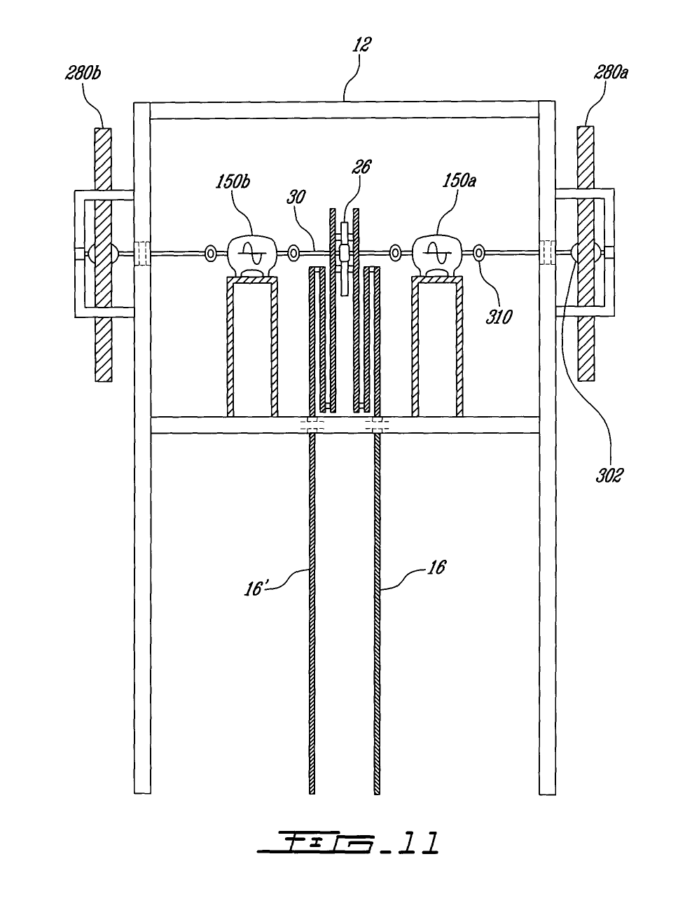

Indeed, a second (or more) pendulum 16′, out of phase with the first pendulum 16, so as to prevent any dead time, may be added (see FIGS. 10, 11), combined with a freewheel 28b of 200 pounds supported by a freewheel 280b of between 3000 to 6000 pounds as needed, as discussed hereinabove.

The drive train 26 ensures that the pendulums 16, 16′ swing with the same period and are maintained out of phase with one another at a predetermined angle.

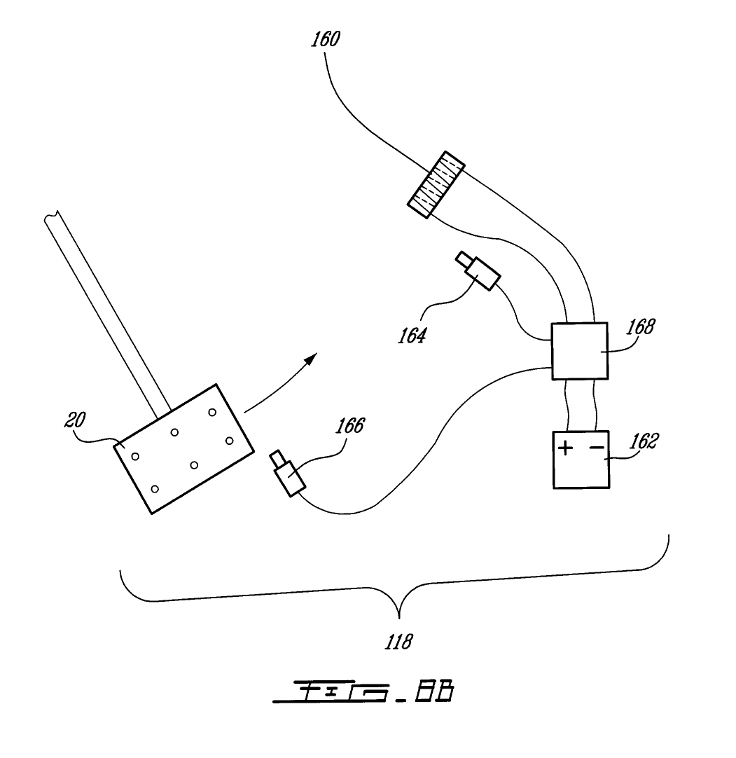

As illustrated in FIG. 7, a generator 150, having a rotor 180, may be directly connected to the flywheel 28 by the drive shaft 30 or on the flywheel 280, and a conversion system 182 provided. The conversion system 182 comprises a rectifier 184 and an inverter 188 controlled by a microprocessor 186, and batteries 190.

The contemplated generator has a slow speed, typically between 180 and 240 RPM, which allows an increased power, of up to 20 kW. The speed depends on the swing amplitude, i.e. on the length of movement between balancing poles. When the variation of the balance point 88 is large, the traction is large on the toothed surfaces 40 and 42 (see FIG. 2). As a result, the pinions 36 and 38 are activated, which increases the speed of the flywheel 28. In contrast, when the variation of the balance point 88 is smooth and small, by reducing the delay between thrusts to the base of the pendulum 16, the speed of the flywheel 28 is low.

For each pendulum 16, 16′, the oscillating movement, once initiated by submitting the mass 20 to an initial force in a direction of pendulation (either to the left or to the right) for example, or by driving one of the weights 75, 77 towards the mass 20, is self-maintained by using gravity under the form of the weights 64 and 62.

In FIG. 11, a first and a second generators 150a, 150b are directly connected to the flywheel 28 by the drive shaft 30, with, on each side, respective flywheels 280a and 280b, using universal joints 310 for example.

The surface of trays 58, 60 may be made in concrete or steel for example, and the weights 75, 77 be provided with wheels, or double bearings, so as to move with minimal friction on the surface of trays 58, 60. Alternatively, the surface of trays 58, 60 could be lubricated so that the weights 75, 77 slide thereon, or the surface could be provided with an air cushion allowing movement of the weights 75, 77 thereon without friction. The links 66, 68, 86 may be flexible steel cables.

The pendulum 16, 16′ at point 22, supporting the mass 20, may have a length up to 4 feet, and the mass 20 may be up to 1000 or 5000 pounds. When a mass 20 of increased weight is selected, blocks 74, 76 of increased weights are automatically needed too. Heavier mass 20 means a lower pushing action needed on weights 75, 77.

In accordance with the present invention illustrated therein the generator 150 may be a DC generator, or a generator providing AC output having either one or three phases. These AC generators would typically be synchronous given that the pendulum period is relatively constant. However, asynchronous generators could also be used if it is intended to operate the mechanism 10 at varying operational speeds (for example, by reducing the arc of oscillation at periods of low power).

Note that, although the generator 150 may be driven by the drive shaft 30 and the flywheel 28 or flywheel 280 as described hereinabove, it is within the scope of the present invention for the generator 150 to be driven directly by the drive shaft 30. For example, the generator 150 may have its rotor 180 directly connected to the drive shaft 30. For example, if the generator is of the induction type (either 1 phase or 3 phase), rotation of the rotor 180 induces alternating current in the stator windings (not shown). Given that the revolutions per minute (RPM) of the drive shaft 30 is typically relatively low, a generator having multiple poles (not shown) could be used in order to produce an alternating current of a higher frequency than the speed of rotation. Additionally, and also alternatively, the alternating current output by the generator could be input into a power conversion system comprised of a rectifier, controlled by a microprocessor, for conversion into a direct current of constant voltage, and then inverted using an inverter (also controlled by the microprocessor) to provide a steady synchronous sinusoidal output current of, for example, 60 Hertz. Additionally, a portion of the energy generated by the generator and converted into DC by the rectifier could be stored in one or more batteries for use during periods of high-energy consumption.

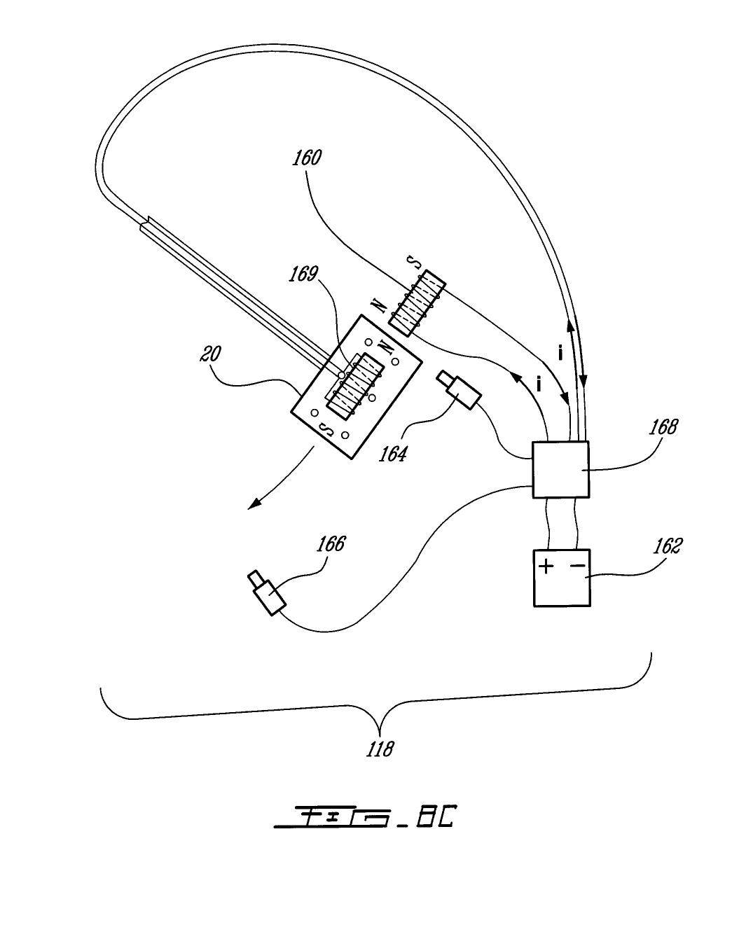

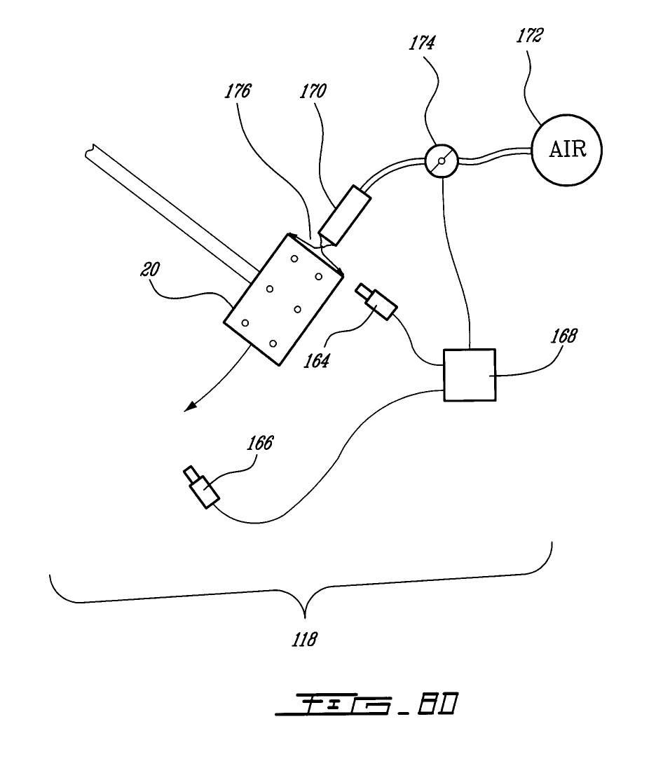

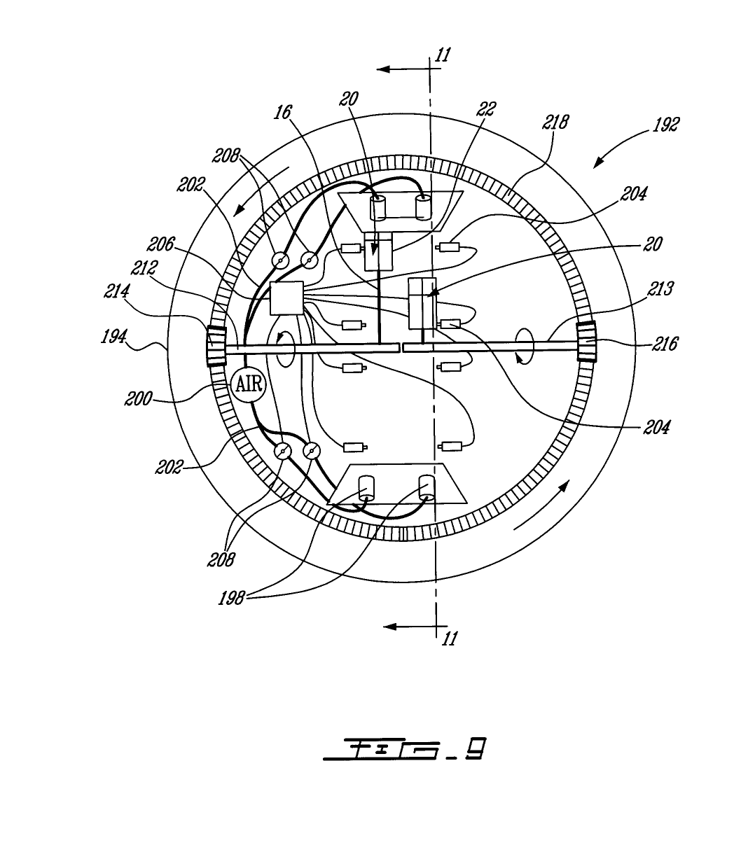

If the gravity system 10, operated by weights 62, 64 under the action of weights 75 and 77 in FIG. 1 (i.e. using weights 62, 64 as actuators), fails, alternative ways, known as redundancies, will have to take over to push the mass 20, as shown for example in FIGS. 8-10. Such redundancies include for example using an electric 12 V DC jack, an air-actuated jack or even a small windmill.

In FIG. 8a, the mass 20 is fabricated at least in part from a polarised magnetic material which forms a magnetic field (not shown), such as a bar magnet or the like, which interacts with a first series of one or more electromagnets 160, such as an iron core solenoid or the like. By supplying a direct current i to the electromagnets, for example via a battery 162, a polarised magnetic field 163 can be generated by the electromagnets 160 which can, depending on polarity, be used to attract or repel the mass 20. In order that the force of attraction or repulsion be applied to the mass 20 only over that portion of the path of travel where it is desired to accelerate the mass 20, a pair of sensors as in 164, 166 can be used to determine the position and direction of travel of the mass 20 along the path of travel and provide this information to a controller 168. The controller 168 then supplies electricity to the electromagnets 160 to either attract or repel the mass 20. The battery 162 can be charged, in part from the output of the generator with provision, as necessary, of an appropriate power conversion and battery charging means (not shown), for example.

In FIG. 8b, the mass 20 is manufactured from a ferrous material such as iron and the electromagnets 160 are excited via the controller 168 and battery 162 to produce a magnetic field, which is used to attract the mass 20 over a portion of the path of travel of the mass 20. As in the example of FIG. 8a, a pair of sensors as in 164, 166 is used to determine the position and direction of travel of the mass 20 along the path of travel and provide this information to the controller 168.

In FIG. 8c, a second series of electromagnets 169, for example iron core solenoids, are integrated into the mass 20. Both series of electromagnets 160, 169 are excited with a direct current i via the controller 168 and battery 162 to produce polarised magnetic fields which are used to either attract and/or repel the mass 20 over a portion of the path of travel of the mass 20 (illustratively, a repelling force is shown in FIG. 8c). As in the example of FIG. 8a, a pair of sensors as in 164, 166 is used to determine the position and direction of travel of the mass 20 along the path of travel and provide this information to the controller 168.

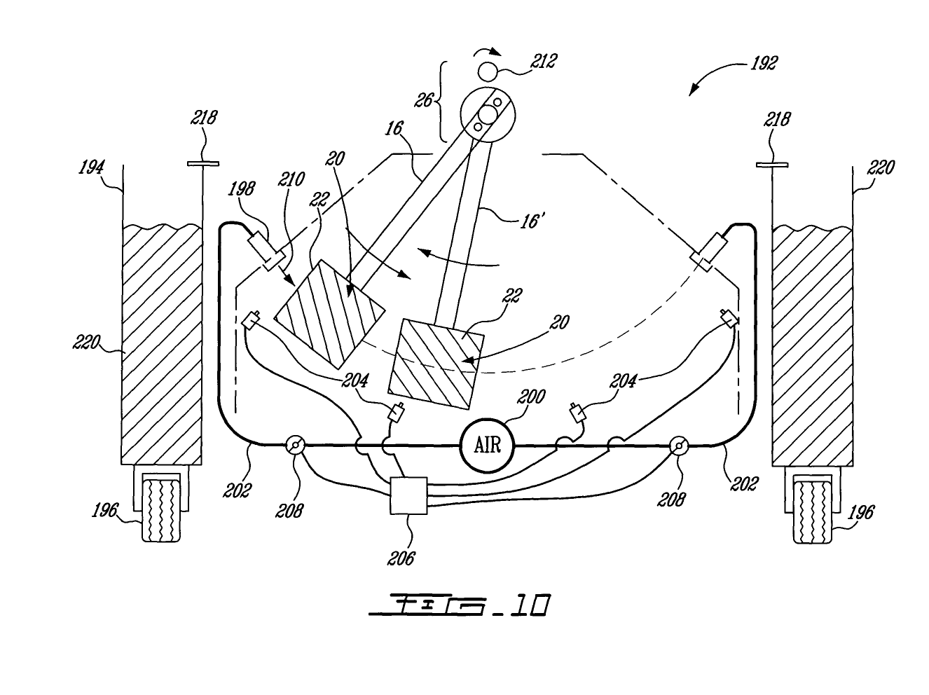

Referring to FIG. 9 and FIG. 10, a power generating system using a pendulum actuated gearing mechanism in accordance with an alternative illustrative embodiment of the present invention, and generally referred to using the reference numeral 192 will now be described.

In FIG. 10, pendulums 16, 16′ and drive train 26 serve to drive an annular container 194 around an axis of rotation, which is perpendicular to the ground. The annular container 194 is mounted on a series of wheels as in 196, for example rubber tires or steel wheels running on a circular steel track or the like (not shown). Illustratively, the pendulation of the pendulums 16, 16′ is maintained by the actuating assembly described hereinabove with reference to FIG. 8D. A series of nozzles as in 198 are interconnected with a source of compressed gas 200, such as compressed air, via a network of hoses 202. Using the outputs of position sensors as in 204 as input, a controller 206 selectively opens and closes a series of valves 208 which release streams of compressed air 210 providing a motive force applied to the mass 20 in the direction of pendulation. The drive train 26, as shown in FIG. 9 for example, includes drive shafts 212, 213 which rotate a pair of cogs 214, 216 located towards the outer ends of the drive shafts 212, 213. The cogs 214, 216 in turn mesh with a toothed upper surface 218 of the annular container 194.

Pendulation of the pendulums 16, 16′ causes the drive shafts 212, 213 and cogs 214, 216 to rotate, thereby driving the annular container 194 in a rotary fashion around an axis of rotation. Additionally, as the annular container 194 begins to rotate at higher speeds, it can be slowly filled with a heavy material 220, for example water mixed with sand or the like, using a pump or the like (not shown), thereby increasing the weight of the annular container 194, and, as a result, the amount of motive energy which can be stored in the system, above or underneath, exactly at the centrifugal point of the container 194.

Although the present invention has been described hereinabove by way of illustrative embodiments thereof, these embodiments can be modified at will without departing from the spirit and nature of the subject invention.

1. A mechanism for driving a generator, comprising:
at least one pendulum comprising a mass free to pendulate about an axis of oscillation;
an actuator for applying a force to said mass in a direction of pendulation for at least a portion of said pendulation; and
a drive train between said at least one pendulum and the generator for transferring energy between said pendulum and the generator.

2. The mechanism of claim 1, wherein said mass is attached at an end of a rod comprising a first part, a second part and a third part, said first part being connected to said mass, said second part being connected between the first part and the third part through a first and a second pivots, a third pivot connecting the third part to said drive train; said pivots allowing a triple lever effect, whereby activation of said first part through action of said mass activates said second and third parts.

3. The mechanism of claim 1, wherein the generator comprises a drive shaft and said drive train comprises a freewheeling clutch mechanism interposed between said at least one pendulum and said drive shaft such that said drive shaft is driven only in a predetermined direction of rotation.

4. The mechanism of claim 1, wherein said at least one pendulum has a periodic motion which is substantially harmonic.

5. The mechanism of claim 1, wherein the generator comprises a drive shaft and said drive train comprises:
a drive member mounted to said at least one pendulum for pendulation therewith;
a wheel, said drive members applying a reciprocating rotational force to said wheel when pendulating, said rotating wheel driving said drive shaft; and
a freewheeling clutch mechanism interposed between said wheel and said drive shaft such that said drive shaft is driven only in a predetermined direction of rotation.

6. The mechanism of claim 1, wherein a freewheeling clutch mechanism is interposed between said wheel and said drive shaft such that said drive shaft is driven only in a predetermined direction of rotation, and said drive member comprises a first and a second racks and said wheel comprises a first and a second pinions.

7. The mechanism of claim 1, wherein a freewheeling clutch mechanism is interposed between said wheel and said drive shaft such that said drive shaft is driven only in a predetermined direction of rotation, and said drive member comprises a belt wound around said capstan and said wheel comprises a capstan.

8. The mechanism of claim 1, wherein a freewheeling clutch mechanism is interposed between said wheel and said, drive shaft such that said drive shaft is driven only in a predetermined direction of rotation and said drive member comprises a chain and said wheel comprises a sprocket.

9. The mechanism of claim 1, wherein a freewheeling clutch mechanism is interposed between said wheel and said drive shaft such that said drive shaft is driven only in a predetermined direction of rotation, and said drive train further comprises a flywheel interposed between said freewheeling clutch mechanism and said drive shaft.

10. The mechanism of claim 1, wherein the generator comprises a drive shaft comprising:
a first rack mounted to said at least one pendulum below said axis of oscillation, for pendulation therewith;
a first pinion, said first rack applying a reciprocating rotational force to said first pinion when pendulating, said rotating first pinion driving said drive shaft, wherein a first freewheeling clutch mechanism is interposed between said first pinion and said drive shaft such that said drive shaft is driven only in a predetermined direction of rotation;
a second rack mounted to said at least one pendulum above said axis of oscillation, for pendulation therewith; and
a second pinion, said second rack applying a reciprocating rotational force to said second pinion when pendulating, said rotating second pinion driving said drive shaft, wherein a second freewheeling clutch mechanism is interposed between said second pinion and said drive shaft such that said drive shaft is driven only in said predetermined direction of rotation.

11. The mechanism of claim 1, comprising two pendulums, wherein said pendulums have an angular velocity which is substantially 90° out of phase.

12. The mechanism of claim 1, wherein said actuator is gravity.

13. The mechanism of claim 1, wherein said actuator comprises a source of energy, wherein when said mass reaches a predetermined position along a path of travel of said mass, energy is released and applied to said mass in the direction of pendulation.

14. The mechanism of claim 1, wherein said mass comprises a ferrous material and said actuator comprises:
at least one electromagnet; and
a source of electrical energy;
wherein when said mass is travelling towards said at least one electromagnet and reaches a predetermined position along a path of travel of said mass, said source of electrical energy is applied to said at least one electromagnet, thereby attracting said mass to said at least one electromagnet.

15. The mechanism of claim 1, wherein said mass comprises a magnetic material and said actuator comprises:
at least one electromagnet; and
a source of electrical energy;
wherein when said mass is travelling away from said at least one electromagnet and reaches a predetermined position along a path of travel of said mass, said source of electrical energy is applied to said at least one electromagnet, thereby repelling said mass from said at least one electromagnet.

16. The mechanism of claim 1, wherein said mass comprises a magnetic material and said actuator comprises:
at least one electro magnetic; and
a source of electrical energy;
wherein when said mass travelling towards said at least one electromagnet reaches a predetermined position along a path of travel of said mass, said source of electrical energy is applied to said at least one electromagnet, thereby attracting said mass to said at least one electromagnet.

17. A mechanism for driving a driveshaft, comprising:
two pendulums, said two pendulums having angular velocities being substantially 90° out of phase; and
a drive train between said two pendulums and said driveshaft for transferring energy between said two pendulums and said driveshaft.

18. A drive train for transferring energy between a pendulum and a drive shaft, comprising:
a drive member mounted to the pendulum for pendulation therewith;
a wheel, said drive member applying a reciprocating rotational force to said wheel when pendulating, said rotating wheel driving the drive shaft; and
a freewheeling clutch mechanism interposed between said wheel and said drive shaft such that the drive shaft is driven only in a predetermined direction of rotation.

19. The drive train of claim 18, further comprising a flywheel interposed between said freewheeling clutch mechanism and said drive shaft.

20. The drive train of claim 18, wherein said drive member comprises a rack and said wheel comprises a pinion.

21. A system for generating electricity, comprising:
a generator;
at least one pendulum comprising a mass, said mass free to pendulate about an axis of oscillation;
an actuator for applying a force to said mass in a direction of pendulation for at least a portion of said pendulation; and
a drive train between said pendulum and said generator for transferring energy between said pendulum and said generator.

22. A method for driving a generator, comprising the steps of:
providing at least one pendulum comprising a mass free to pendulate about an axis of oscillation;
applying a force to the mass in a direction of pendulation for at least a portion of said pendulation;
interconnecting a drive shaft with the generator such that the generator rotates therewith; and
converting the pendulation into a rotational movement using a drive train, the drive train rotating the driveshaft in a predetermined direction of rotation.

23. The method of claim 22, wherein the drive train comprises:
a drive member mounted to the pendulum for pendulation therewith;
a wheel, the drive member rotating the wheel when the pendulum is pendulating, the rotating wheel driving the drive shaft; and
a freewheeling clutch mechanism interposed between the wheel and the drive shaft such that the drive shaft is driven in the predetermined direction of rotation.
